(19) United States
(12) Patent Application Publication
(10) Pub. No.: US 2015/0044354 A1
(43) Pub. Date: Feb. 12, 2015

(54) COCONUT OPENING DEVICE

(71) Applicant: Viet Tran, Huntington Beach, CA (US)

(72) Inventor: Viet Tran, Huntington Beach, CA (US)

(21) Appl. No.: 13/962,128

(22) Filed: Aug. 8, 2013

(51) Int. Cl. A23N 5/03; A23L 2/02

(52) U.S. Cl. CPC A23N 5/03; A23L 2/02
USPC 426/599; 83/162

(57) ABSTRACT

A coconut opening device is disclosed. The device may be fixedly secured to the top of a coconut, preferably, a young coconut. The coconut opening device may have a punch which is initially set to an up position and sold to consumers in this state. The consumer, after purchasing the coconut, may traverse the punch from the up position to an engaged position. In the engaged position, the punch which may be hollow provides access to the coconut milk.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The various embodiments disclosed herein relate to a coconut opening device.

Coconut milk is a refreshing and enjoyable drink enjoyed by many different cultures and peoples. The best tasting coconut milk is that which comes straight from the coconut in an unprocessed form. To this end, many stores and businesses sell whole coconuts to consumers for later consumption. Unfortunately, it is very difficult to open the coconut due to the hard outer shell. Consumers must utilize a sharp knife to open the coconut and access the coconut milk. The sharp knife makes opening and accessing the coconut milk dangerous and time-consuming. As a result, consumers must often resort to processed coconut milk or prepackaged coconut milk.

Accordingly, there is a need in the art for an improved method and device for opening a coconut and accessing the coconut milk.

### BRIEF SUMMARY

The various embodiments disclosed herein address the needs discussed above, discussed below, and those that are known in the art. A coconut opening device is disclosed herein which allows a consumer to safely and quickly access coconut milk of the coconut without the use of a sharp knife. The coconut opening device may be secured to the coconut by way of anchors or straps. The coconut opening device has a punch which is initially set to an up position. In the up position, the punch does not engage the coconut. When the consumer wants to access the coconut milk of the coconut, the consumer traverses the punch from the up position to an engaged position. The punch pierces through the coconut so that the consumer can access the coconut milk. The punch may be hollow along its longitudinal axis and have side and/or bottom through-holes that allow the coconut milk to be drained from the coconut or a straw inserted through the punch. To traverse the punch from the up position to the engaged position, the punch may be threaded and mate with mating threads on a neck of the coconut opening device. The punch is rotated to engage the respective threads and slowly traverse the punch from the up position to the engaged position to pierce through the coconut for accessing the coconut milk in a quick and safe manner.

More particularly, an apparatus for providing access to the milk of a coconut is provided. The apparatus may comprise a base, a neck and a punch. The base may be sized and configured to receive the coconut so that the base is fixedly secured to the coconut. The neck may extend upwardly from the base. The punch is traversable along the neck between an up position and an engaged position. The punch may have a lower sharp leading edge for cutting through the skin of the coconut. The punch may also have a hollow center so that a person may drink the milk within the coconut after the punch is traversed to the engaged position.

The punch is threadably engaged to the neck. The neck may have an external thread and the punch may have an internal thread threadably engaged with each other. The punch may also have a cap which is removably attachable to its upper end to cover the hollow interior of the punch prior to use of the apparatus. The apparatus may additionally have a removable sleeve that is disposed between a footing and the punch to prevent premature engagement of the punch to the coconut.

Moreover, a drink is disclosed. The drink may comprise a coconut and an apparatus. The coconut may have a top surface exposing a skin of the coconut. The apparatus is provided for quickly and safely accessing the milk of the coconut. In particular, the apparatus may comprise a base, a neck and a punch. The base may have a configuration matching the configuration of the top surface of the coconut and is fixedly secured to the base of the coconut. The neck may extend upwardly from the base. The punch may traverse along the neck between an up position and an engaged position. The punch may also have a lower sharp leading edge for cutting through the skin of the coconut. The punch may also have a hollow center so that a person may drink the milk within the coconut after the punch has been traversed to the engaged position.

The top surface of the coconut may be flat. Moreover, the base may have one or more receiving holes and the apparatus may further comprise one or more straps that fixedly engage the one or more receiving holes of the base to fixedly secure the apparatus to the coconut.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a cross-sectional view of a first embodiment of a coconut opening device and coconut wherein a punch of the coconut opening device is disposed at an up position;

FIG. 2 is a cross-sectional view of a second embodiment of the coconut opening device and coconut wherein the punch of the coconut opening device is disposed at an up position;

FIG. 3 is a cross-sectional view of the first embodiment of the coconut opening device shown in FIG. 1 wherein the punch of the coconut opening device is disposed at an engaged position;

FIG. 4 is a cross-sectional view of the second embodiment of the coconut opening device wherein the punch of the coconut opening device is disposed at the engaged position; and

FIG. 5 is an exploded view of the first embodiment of the coconut opening device attached to a pre-shaped coconut.

### DETAILED DESCRIPTION

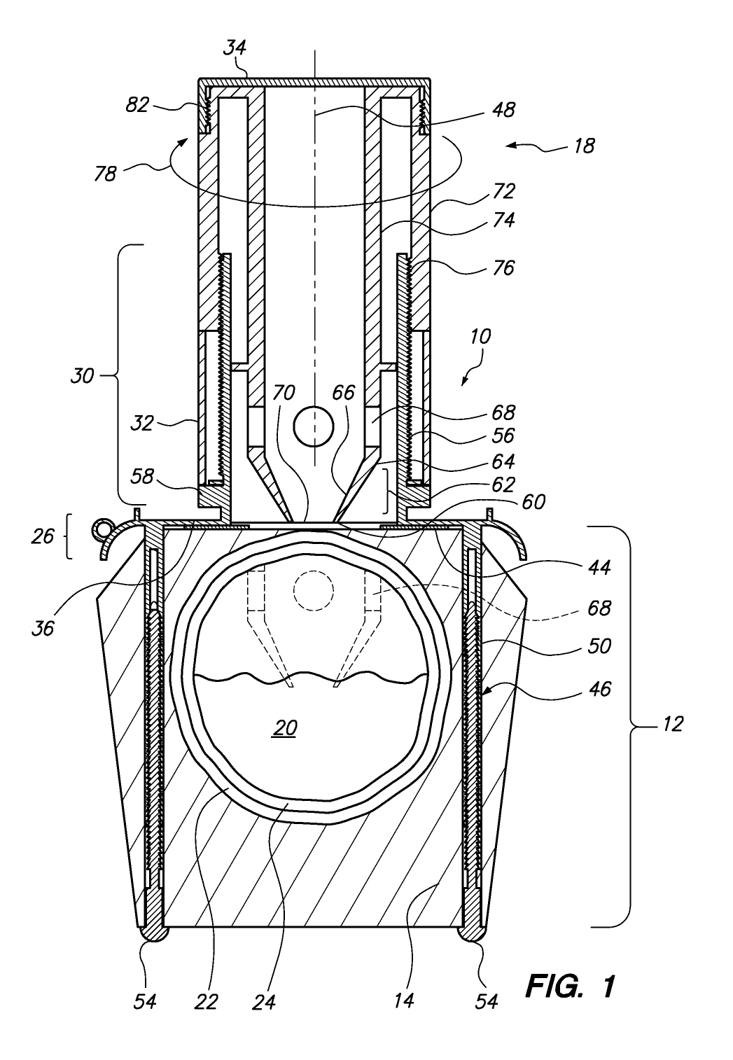

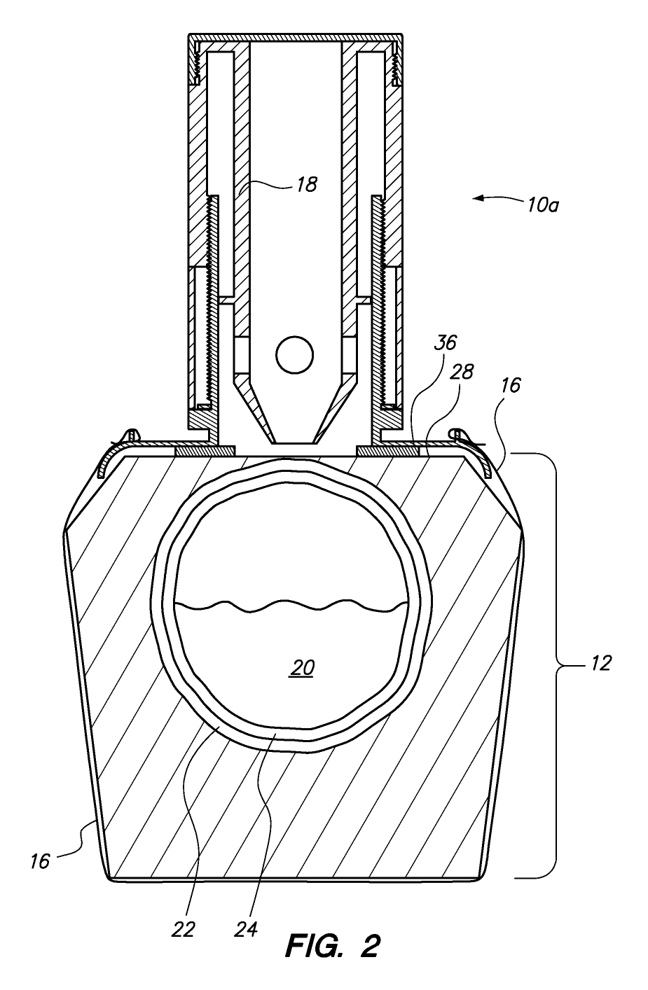

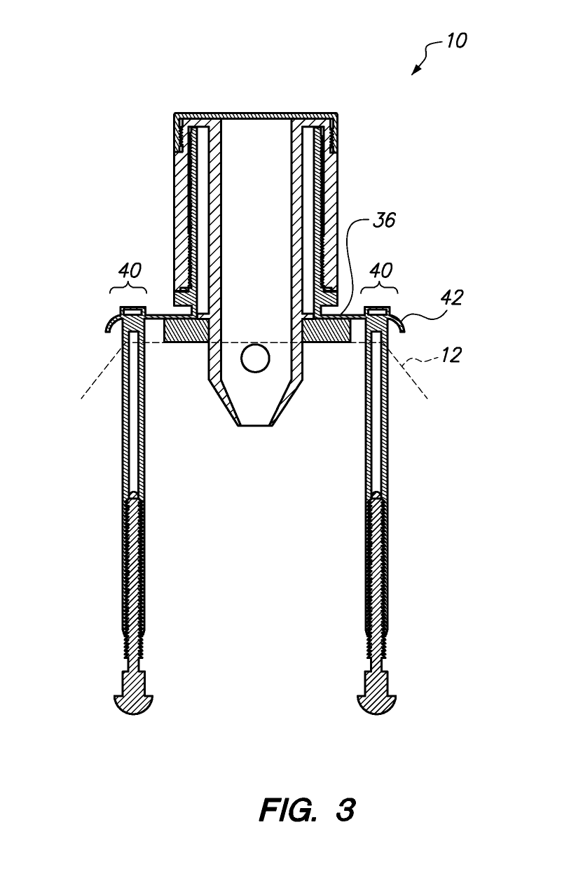

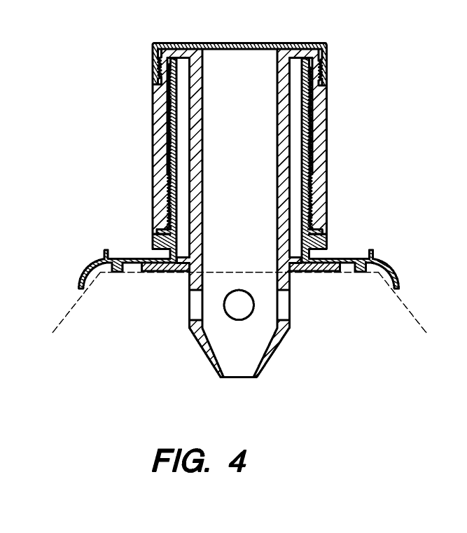

Referring now to the drawings, a coconut opening device 10, 10a is shown. The coconut opening device 10 may be mounted to a coconut 12 either by drilling mounting holes through an outer skin 14 of the coconut 12 (see FIG. 1) or by wrapping one or more straps 16 around the coconut 12 (see FIG. 2). The coconut opening device 10, 10a includes a punch 18 which is initially disposed in an up position as shown in FIGS. 1 and 2. The punch 18 does not engage the coconut 12 while in the up position. After purchase or when the user wants to access the coconut milk 20, the operator traverses the punch 18 from the up position to an engaged position as shown in FIGS. 3 and 4. In the engaged position, the punch 18 penetrates the inner shell 22 of the coconut 12 as well as the coconut meat 24 to access the coconut milk 20. The punch 18 is hollow to provide fluid communication to the interior liquid contents 20 of the coconut 12. The operator may drink the coconut milk 20 by removing a cover 34 and inserting a straw through the punch 18 or by tilting the coconut 12 and pouring the coconut milk 20 into his or her mouth or cup. Accordingly, the coconut opening device 10, 10a provides a convenient and safe method of accessing the coconut milk 20 by a consumer.

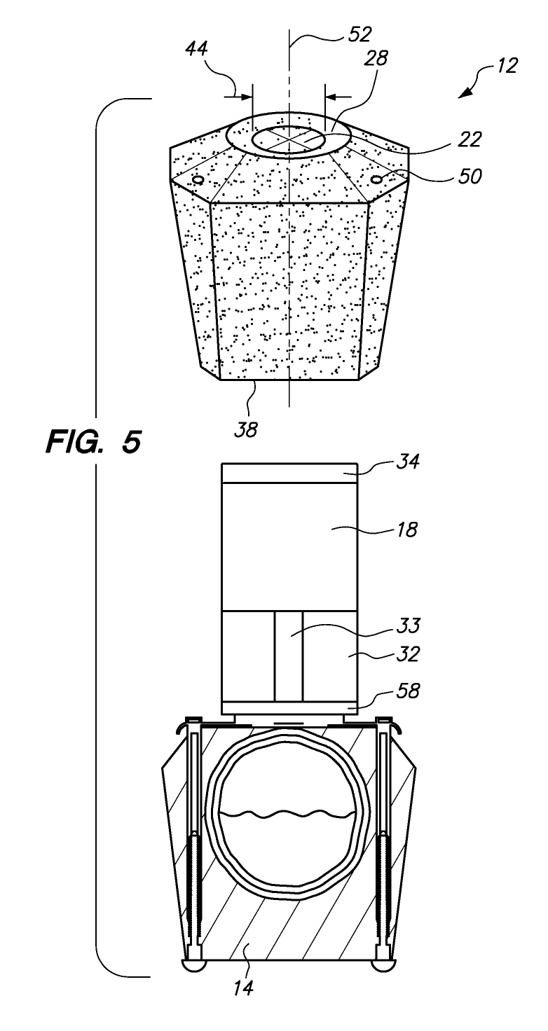

Referring now to FIGS. 1, 3 and 5, the coconut opening device 10 may include a base 26 that is sized and configured to engage an exterior surface 28 (see FIG. 5) of the coconut 12. A neck 30 of the coconut opening device 10 may be fixedly attached to the base 26 either by forming the neck 30 and the base 26 as a unitary structure or by attaching the neck 30 to the base 26 by means known in the art or developed in the future. The punch 18 is traversable through the neck 30 from the up position to the engaged position. The punch 18 may be prevented from inadvertently or prematurely being traversed to the engaged position by forming a detachable and removeable sleeve 32 disposed between the punch 18 and a footing 58. To traverse the punch 18 to the engaged position, the operator must remove the sleeve 32, then traverse the punch 18 to the engaged position. As shown in FIG. 5, the sleeve 32 has a finger slot 33 by which the user can peel off the sleeve from the punch 18. A top portion of the punch 18 may have a cover 34 to prevent contamination of the hollow interior of the punch 18 during storage.

The base 26 of the coconut opening device 10 may have a generally circular disk 36 configuration when viewed from the top. Although a circular flat disk configuration is contemplated, other configurations are also contemplated such as concave, square, irregularly shaped, etc. Preferably, the disk 36 mates with a corresponding exterior mounting surface 28 of the coconut 12. As shown in FIG. 5, the coconut 12 may be prepared so that mounting of the coconut opening device 10 may be more easily facilitated. In particular, the husk of the coconut 12 may be removed from the coconut 12. The outer skin 14 of the coconut 12 may be shaped in the configuration shown in FIG. 5. In particular, the outer skin 14 may be shaped with a bottom flat surface 38 so that the coconut 12 may be placed on a table or a flat support surface to orient the coconut 12 in the upright position. Moreover, the upper portion of the coconut 12 may have a generally flat exterior surface 28 that exposes a small portion 44 of the inner shell 22. Accordingly, the generally flat exterior surface 28 of the coconut 12 exposes both the outer skin 14 and the inner shell 22. During operation, the punch 18 pierces a hole through the inner shell 22 and the meat 24 to access the coconut milk 20. Alternatively, it is also contemplated that the punch 18 may be positioned and designed so as to be capable of piercing through the outer skin 14, the inner shell 22 and the meat 24 as well. When the exterior surface 28 of the coconut 12 is flat, the disk 36 may also be generally flat as shown. An outer peripheral portion 40 of the disk 36 may have a downturned edge 42.

Referring back to FIG. 1, the flat disk 36 of the coconut opening device 10 may engage the exterior surface 28, and more particularly, the top portion of the coconut 12. Preferably, the underside surface of the flat disk 36 and the top portion of the coconut 12 may both have complementary configurations such as flat, concave/convex. In this manner, when the coconut opening device 10 is secured to the coconut 12, substantial surface contact exists between the disk 36 and the coconut 12 to prevent the coconut opening device 10 from slipping or moving as the user punctures a hole through the coconut 12 with the coconut opening device 10 as discussed herein. Optionally, a pad 44 may be disposed between the flat disk 36 and the top portion of the coconut 12. The pad 44 may have a washer configuration and a thickness of about 0.2 inches. The pad 44 may circumscribe the area of the coconut 12 punctured by the punch 18.

One or more anchors 46 may extend below the disk 36. The anchors may be evenly distributed about the axis 48 of traversal of the punch 18. The axis 48 if defined by the travel of the punch 18 as it is traversed from the up position to the engaged position. By way of example and not limitation, there may be four anchors 46 distributed about the traversal axis 48 separated at 90° spacing about the traversal axis 48. As shown in FIG. 5, the coconut 12 may have one or more through holes 50 through which the anchors 46 are inserted and secured to the coconut 12. Two through holes 50 on the backside of the coconut 12 are not shown in FIG. 5. These through holes 50 are separated at about 90° from each other about a vertical axis 52 so that the anchors 46 are aligned to the through holes 52. To mount the coconut opening device 10 to the coconut 12, the anchors 46 are inserted through the through holes 50. At this time, the disk 36 engages the top portion of the coconut 12. Optionally, the pad 44 may be disposed between the disk 36 and the top portion of the coconut 12. Also, the vertical axis 52 of the coconut 12 is aligned to the traversal axis 48 of the punch 18. After inserting the anchors 46 into the through holes 50, mating plugs 54 may be inserted through the underside of the coconut 12 into the through holes 50 and mate with the anchors 46. The plugs 54 may have an elongate configuration with a plurality of ribs extending along a length of the plug 54. Additionally, the anchors 46 may have a hollow interior cavity having opposing ribs that mate with the plurality of ribs of the plug 54. By way of example and not limitation, the ribs of the plug 54 may be directed downwardly when the plug 54 is in the orientation shown in FIG. 1. These downwardly pointed ribs allow the user to push the plug 54 into the hollow interior cavity of the anchor 46. The mating ribs within the hollow interior cavity of the anchors 46 may have upwardly directed ribs. As the plug 54 is inserted into the hollow interior cavity of the anchors 46, the respective ribs begin to engage each other. As the plug 54 is inserted more deeply into the hollow interior cavity of the anchor 46, more and more of the respective ribs engage each other and prevent removal of the plug 54 from the anchor 46. The plug 54 may have an enlarged head which is larger than the through holes 50 so that the head of the plug 54 cannot be pulled through the through hole 50 during transportation or when the punch 18 is being traversed to the engaged position. The head of the plug 54 provides the stabilizing force that secures the coconut opening device 10 to the coconut 12.

The neck 30 of the coconut opening device 10 may extend upward from the disk 36. The neck 30 may have a cylindrical configuration with external threads 56. The internal surface of the neck 30 may also have a cylindrical configuration. The neck 30 may also have a footing 58 which extends radially outward and extends beyond the threads 56 of the neck 30. As discussed above, the sleeve 32 is disposed between the punch 18 and the footing 58. When the sleeve 32 is in place as shown in FIG. 1, the punch 18 cannot be traversed to the engaged position because the sleeve 32 prevents the downward traversal of the punch 18. The length of the threads 56 may be sufficient to traverse the distal end of the punch 18 through the skin 14, inner shell 22 and the meat 24 of the coconut 12.

The punch 18 may have a tubular configuration. A distal end 60 may have a sharp edge to puncture through the skin 14, inner shell 22 and the meat 24 of the coconut 12 as the punch 18 is traversed from the up position to the engaged position. The sharp distal end 60 cuts through the coconut 12 without creating shavings that might contaminate the coconut milk 20 as the punch 18 punctures through the coconut 12. A distal end portion 62 may have a conical exterior surface 64. Additionally, the distal end portion 62 may have a corresponding conical interior surface 66. The conical exterior surface 64 helps to push away the skin 14, inner shell 22 and the meat 24 as the punch 18 proceeds to the engaged position. The punch 18 may additionally have a plurality of lateral through holes 68. These lateral through holes 68 are disposed past the meat 24 of the coconut 12 when the punch 18 is in the engaged position. A bottom hole of the punch 18 may be plugged by the skin 14, inner shell 22 and the meat 24 as the distal end 60 of the punch 18 cuts through the coconut 12. These lateral through holes provide fluid communication from the interior of the meat 24 to the interior of the punch 18 so that the coconut milk 20 may be poured out through the punch 18. If the bottom hole 70 of the punch 18 is not plugged, the straw may be inserted through the punch 18 so that the user may drink the coconut milk 20.

The punch 18 may additionally have an external sleeve 72. The external sleeve 72 of the punch 18 may be connected to an internal tube 74. The external sleeve 72 may have internal threads 76 that engage the external threads 56 of the neck 30.

During operation, the coconut 12 is sold to a consumer with the coconut opening device 10 attached to the coconut 12. At the store, the punch 18 of the coconut opening device 10 does not inadvertently or prematurely puncture the coconut 12 and spill the coconut milk 20. The reason is that sleeve 32 prevents actuation or traversal of the punch 18 to the engaged position. The consumer may purchase the coconut 12 with the coconut opening device 10 attached thereto at a retail store or at some other location such as a county fair. The consumer may access the coconut milk 20 by removing the sleeve 32 from between the punch 18 and the footing 58. In the diagram shown in FIG. 1, the sleeve 32 is a part of the punch 18. In particular, the sleeve 32 is attached to the external sleeve 72 of the punch 18 but perforated so that the sleeve 32 can be peeled or ripped off. The sleeve 32 also functions as a tamper proof seal. Once the sleeve 32 is removed from the punch 18, the user may grip the external sleeve 72 and twist the external sleeve 72. Preferably, the threads 56, 76 of the neck 30 and the external sleeve 72 are right-handed threads. The external sleeve 72 is traversed downward upon counterclockwise twisting of the punch 18, as shown by the direction arrow 78. The consumer twists the punch 18 in the counterclockwise direction 78 until the distal end 60 of the punch 18 cuts through the inner shell 22 and the coconut meat 24 and the lateral through holes 68 formed in the internal tube 74 are disposed within the hollow cavity formed by the coconut meat 24. The punch 18 can be traversed to the engaged position until a distal end 80 of the external sleeve 72 contacts the footing 58. The distal end 60 of the punch 18 is sharp enough so that small particulate matter (i.e., shavings) is not formed as the distal end 60 twists and cuts through the inner shell 22 in the coconut meat 24. This minimizes contamination of the coconut milk 20. Once the punch 18 is in the engaged position, the user may remove the cap 34 from the upper portion of the punch 18. The cap 34 may have mating threads 82 which mate with the external sleeve 72. Alternatively, the cap 34 may have a lip which engages a corresponding lip on the punch 18 so that the cap 34 may be merely pushed off the punch 18 to access the coconut milk 20.

In an alternate embodiment shown in FIGS. 2 and 4, the coconut opening device 10a may be secured to the coconut 12 by way of straps 16. The straps 16 are secured to one side of the disc 36, wrapped around and under the coconut 12 and secured to the other side of the disc 36. A sufficient number of straps 16 may be utilized to securely maintain the coconut opening device 10 to the coconut 12. The straps may be an elongate wire or elongate plastic membrane. The various aspects of the first embodiment of the coconut opening device are also applicable to the second embodiment of the coconut opening device. The difference between the first and second embodiments may be in the means of attaching the coconut opening device to the coconut.

The various aspects of the device discussed herein was discussed in relation to a coconut. However, the device may be applied to other types of food product where it is crucial to access a center of the food product. It is also contemplated that the device may be used to punch a hole in a non-food product as well. Moreover, the coconut in the examples provided herein is related to a young coconut but it may also be applied to other types of coconuts including but not limited to a mature coconut. Additionally, the punch 18 discussed herein in traversed from the up position to the engaged position by way of mating threads of the punch 18 and the neck 30. However, it is also contemplated that the punch 18 and the neck 30 do not have mating threads. Rather, they slide upon one another. The neck 18 would direct the travel path of the punch 18 from the up position to the engaged position. To traverse the punch 18 to the engaged position, the user would remove the sleeve 32 and push the punch 18 to the engaged position with a mallet or the palm of the person's hand.

The above description is given by way of example, and not limitation. Given the above disclosure, one skilled in the art could devise variations that are within the scope and spirit of the invention disclosed herein, including various ways of attaching the device to the coconut. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An apparatus for providing access to a milk of a coconut, the apparatus comprising:
a base sized and configured to receive the coconut so that the base is fixedly secured to the coconut;
a neck extending upwardly from the base;
a punch traverseable along the neck between an up position and an engaged position, the punch having a lower sharp leading edge for cutting through a skin of the coconut, the punch having a hollow center so that a person may drink the milk within the coconut after the punch has been traversed to the engaged position.

2. The apparatus of claim 1 wherein the punch is threadably engaged to the neck.

3. The apparatus of claim 2 wherein the neck has an external thread and the punch has an internal thread engaged to the external thread of the neck.

4. The apparatus of claim 1 further comprising a cap removably attachable to an upper end of the punch to cover the hollow interior of the punch prior to use of the apparatus.

5. The apparatus of claim 1 further comprising a removable sleeve between a footing and the punch to prevent premature engagement of the punch to the coconut.

6. A drink comprising:
a de-husked coconut with a top surface exposing a skin of the de-husked coconut;
an apparatus for providing access to a milk of the coconut, the apparatus comprising:
a base having a configuration matching the configuration of the top surface of the de-husked coconut fixedly securing the base to the coconut;
a neck extending upwardly from the base;
a punch traverseable along the neck between an up position and an engaged position, the punch having a lower sharp leading edge for cutting through the skin of the coconut, the punch having a hollow center so that a person may drink the milk within the coconut after the punch has been traversed to the engaged position.

7. The drink of claim 6 wherein the top surface of the coconut is flat.

8. The drink of claim 6 wherein the base has one or more receiving holes and the apparatus further comprises one or more straps that fixedly engage the one or more receiving holes to fixedly secure the apparatus to the coconut.
